(19) United States
(12) Patent Application Publication
(10) Pub. No.: US 2015/0289646 A1
(43) Pub. Date: Oct. 15, 2015

(54) STORAGE SYSTEMS FOR HOLDING AND/OR STORING ITEMS

(71) Applicant: Comfort Insight, LLC, Ballwin, MO (US)

(72) Inventor: Michelle Stapp, Ballwin, MO (US)

(21) Appl. No.: 14/683,386

(22) Filed: Apr. 10, 2015

Related U.S. Application Data
(60) Provisional application No. 61/978,703, filed on Apr. 11, 2014.

(51) Int. Cl. A47B 67/02; F21V 33/00; G02B 7/02; A47B 81/00; A44B 18/00

(52) U.S. Cl. CPC A47B 67/02; A47B 81/00; A44B 18/00; G02B 7/02; F21V 33/0012; F21W 2131/301

(57) ABSTRACT

A storage system for items generally includes a support for holding the items on the support and an imaging unit coupled to the support for use in viewing the items. The support defines an opening, and the imaging unit is moveable relative to the support between a first position in which the imaging unit is disposed generally within the opening of the support and a second position in which the imaging unit is disposed generally outside of the opening, for use in viewing the items. Lights are provided in the system to help illuminate the items held on the support. The lights may be automatically activated, as desired, by the imaging unit, for example, when the imaging unit moves relative to the support, such that the lights can help facilitate viewing of the items, with the imaging unit, held by the support.

### CROSS-REFERENCE TO RELATED APPLICATIONS

This application claims the benefit of, and priority to, U.S. Provisional Application No. 61/978,703, filed on Apr. 11, 2014. The entire disclosure of the above application is incorporated herein by reference.

### FIELD

The present disclosure generally relates to storage systems for holding and/or storing items, and for facilitating viewing of the items.

### BACKGROUND

This section provides background information related to the present disclosure which is not necessarily prior art.

As shown in FIGS. 14 and 15, cabinets (e.g., cabinet 1a, 1b, etc.) and shelves (e.g., shelves 3a and 3b, etc.) are often used for holding and storing items (e.g., items 5, etc.). The items can be placed on top of the shelves in the cabinets, or on top of counters (e.g., counter 7, etc.) associated with the cabinets.

### SUMMARY

This section provides a general summary of the disclosure, and is not a comprehensive disclosure of its full scope or all of its features.

Exemplary embodiments of the present disclosure generally relate to storage systems for items. In one exemplary embodiment, a system of the present disclosure generally includes a support for holding items where at least a portion of the support defines an opening, and an imaging unit coupled to the support. The imaging unit is moveable between a first position in which the imaging unit is disposed generally within the opening of the support and a second position in which the imaging unit is disposed generally outside of the opening, for use in viewing the items when held by the support.

In another exemplary embodiment, a storage system of the present disclosure generally includes a housing having coupling material for releasably coupling one or more items to the housing, a magnifying lens coupled to the housing and moveable between a plurality of positions relative to the housing to allow a user to selectively magnify at least a portion of one or more items coupled to the housing, and one or more lights configured to automatically turn on when the magnifying lens is moved relative to the housing to provide light to at least a portion of the one or more items coupled to the housing to assist the user in viewing text and/or images on the one or more items.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary embodiment of a storage system according to the present disclosure for use in holding and/or storing items, with an imaging unit of the storage system shown in a stored position;

FIG. 2 is the perspective view of FIG. 1, with the imaging unit shown in an extended position to help facilitate viewing the items in the storage system;

FIG. 3 is a perspective view of an item that can be held and/or stored in the storage system of FIG. 1, showing a coupling material disposed on a cover portion of the item for use in coupling the item to the support of the storage system;

FIG. 4 is a front view of the storage system of FIG. 1, with the items removed;

FIG. 5 is a section view taken in a plane including line 5-5 in FIG. 4;

FIG. 6 is the front view of FIG. 4, with the imaging unit shown in the extended position;

FIG. 7 is a section view taken in a plane including line 7-7 in FIG. 6;

FIG. 8 is the front view of FIG. 6, with the imaging unit shown moved along a front portion of the support of the storage system;

FIG. 9 is a section view taken in a plane including line 9-9 in FIG. 4;

FIG. 10 is an exploded perspective view of another exemplary embodiment of a storage system according to the present disclosure, configured for installation to an underside of a cabinet;

FIG. 11 is a perspective view of the storage system of FIG. 10 shown installed to the cabinet and with items being held and/or stored thereon;

FIG. 12 is a perspective view of another exemplary embodiment of a storage system according to the present disclosure, configured for installation to a medicine cabinet;

FIG. 13 is the perspective view of FIG. 12, with a door of the medicine cabinet removed and with items shown being held and/or stored in the medicine cabinet using the storage system;

FIG. 14 is a perspective view of a medicine cabinet with items positioned on shelves therein; and

FIG. 15 is a perspective view of a kitchen cabinet and counter with items positioned on the counter.

Corresponding reference numerals indicate corresponding parts throughout the several views of the drawings.

### DETAILED DESCRIPTION

The inventor hereof has developed, and discloses herein, exemplary embodiments of storage systems for holding and/or storing items, and for helping with viewing the items in the storage systems. The items may include, but are not limited to, storage containers, bottles, boxes, other containers, medicine, prescriptions, etc. In use, the storage systems may provide assistance to users in holding/storing the items, and/or in viewing the held/stored items, and/or in retrieving the held/stored items.

In some exemplary embodiments, the storage systems may include supports (e.g., support surfaces, housings, shelves, etc.) for coupling to existing cabinets and/or shelves (e.g., medicine cabinets and/or shelves, kitchen cabinets and/or shelves, other shelving units, other shelves, etc.). In some aspects, the supports may include adhesive materials, fasteners, other coupling materials/equipment, etc. for coupling the supports to portions (e.g., lower portions, underside portions, etc.) of the cabinets and/or shelves. In other aspects, the supports may be used directly as shelves, for example, in cabinets, along walls, etc.

In some exemplary embodiments, the supports of the storage systems may include coupling material (e.g., disposed on lower side portions of the supports, etc.), and the items to be held/stored in the storage systems may include corresponding (e.g., mating, etc.) coupling material (e.g., disposed on lids, covers, upper portions, etc. of the items; etc.) for use in releasably coupling the items to the supports. In some aspects, the coupling material may include hook and loop coupling material (e.g., Velcro®, etc.). In other aspects, the coupling material may include magnetic material, or other material that can facilitate releasably coupling the items to the supports (e.g., to lower side portions of the supports, to underside portions of the supports, etc.).

In some exemplary embodiments, the storage systems may include imaging units (e.g., magnifying lenses, cameras, etc.) configured to assist users in viewing items held/stored in the storage systems (e.g., text, print, images, etc. on the items; etc.). In these embodiments, supports of the storage systems may include structures (e.g., openings, housings, attachments, etc.) configured to store the imaging units when not in use, and to allow the imaging units to move to desired positions relative to items held/stored in the storage systems for use in viewing the items. In some aspects, the imaging units are coupled to the supports to allow for movement of the imaging units, relative to the supports, between various positions (e.g., between stored positions where the imaging units are in the storage structures and extended positions where the imaging units are used to view the items, to multiple different positions along the supports to allow for viewing items in the support systems, etc.).

In some exemplary embodiments, the storage systems may include lights to assist users in viewing items being held/stored in the storage systems. In some aspects, the lights may be associated with supports of the storage systems (e.g., disposed along lower side portions of the supports to facilitate lighting forward facing portions of items releasably coupled to the supports, etc.). In other aspects, the lights may be associated with imaging units of the support systems (e.g., disposed along rearward facing portions of the imaging units to facilitate lighting forward facing portions of items in the support systems, etc.). In still other aspects, the lights may be associated with both supports and imaging units of the support systems. In various embodiments, the lights may be selectively activated, as desired, to help access, view, etc. the items in the storage systems (e.g., automatically upon accessing the support systems, automatically upon movement of the imaging units, via manual switches, via various commands, via other movements, etc.).

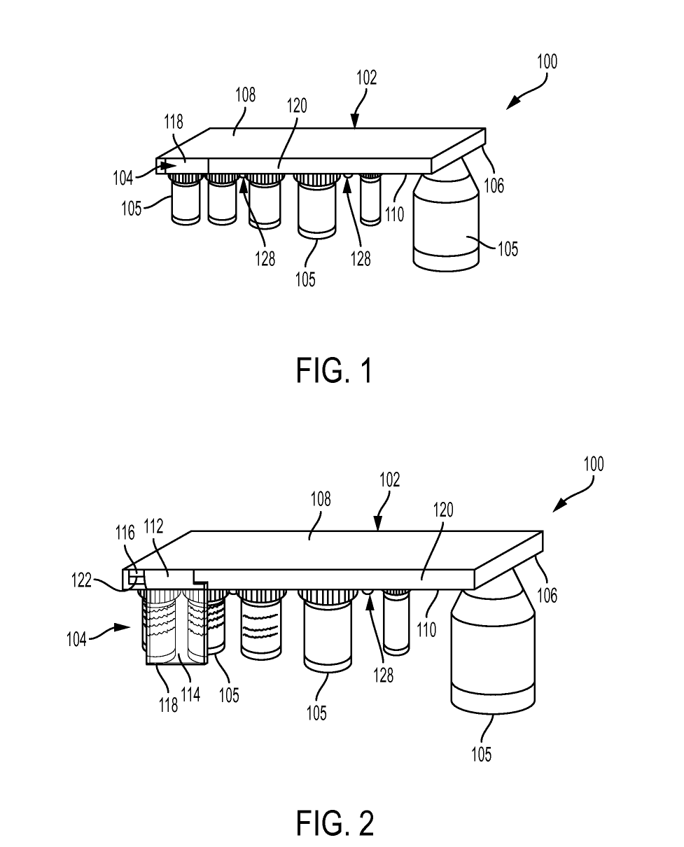

With reference now to the drawings, FIGS. 1-9 illustrate an exemplary embodiment of a storage system 100 including one or more aspects of the present disclosure. The storage system 100 can be used to hold and/or store items 105, and to facilitate viewing of the items 105, as desired, in the storage system 100. Without limitation, the storage system 100 can be installed to existing cabinets, shelves, etc., or can be used directly as a shelf. And, the items 105 that can be held and/or stored in the storage system 100 may include, but are not limited to, storage containers, bottles, boxes, other containers, medicine, prescriptions, etc.

As shown in FIGS. 1 and 2, the illustrated storage system 100 generally includes a support 102 (e.g., a housing, etc.) for holding and/or storing the items 105 in the storage system 100, and an imaging unit 104 for assisting a user in viewing the items 105. In use, the items 105 can be positioned generally along a lower portion 106 (e.g., a lower surface, a lower side, etc.) of the support 102 (as illustrated in FIGS. 1 and 2), and a user can then move the imaging unit 104 relative to the items 105 to selectively enhance viewing of desired items 105. And, although FIGS. 1 and 2 illustrate the items 105 and imaging unit 104 disposed along the lower portion 106 of the support 102, it should be appreciated that in other embodiments the imaging unit 104 and/or the items 105 may be located/positioned along an upper portion 108 of the support 102. In addition, items 105 may be located along both the lower portion 106 and the upper portion 108 of the support 102, with the imaging unit 104 then available (e.g., adjustable, moveable, etc.) for viewing the items 105 along both portions 106, 108 of the support 102.

In the illustrated embodiment, the support 102 is configured to couple to an underside of a shelf or cabinet. As an example, an adhesive may be disposed on the upper portion 108 of the support 102 for use in coupling the support 102 to the underside of the shelf or cabinet. Alternatively, other materials (e.g., fasteners, etc.) may be used for coupling the support 102 to the underside of the shelf or cabinet. Further, it should be appreciated that the support 102 may be used directly as a shelf, with or without being coupled to other structure, within the scope of the present disclosure. Also in the illustrated embodiment, the support 102 is generally rectangular in shape (when viewed generally from above), but other embodiments may include supports having different shapes (e.g., square shapes, circular shapes, oval shapes, etc.). Moreover, the support may have any desired size, for example, depending on the application and/or installation location. In some example embodiments (and without limitation), for example, the support may have a width dimension of about 11 inches and a height dimension of about 0.875 inches.

Coupling material 110 is used for releasably coupling the items 105 to the support 102. The coupling material 110 may include any suitable material within the scope of the present disclosure, such as hook and loop material (e.g. Velcro®, etc.), magnetic material, removable adhesive material, etc. In use, the coupling material 110 can be attached to desired portions of the support 102 and to desired portions of the items 105 using any suitable connecting material (e.g., adhesive, tape, glue, etc.). Alternatively, at least a portion of the support 102 and/or the items 105 may be constructed from the coupling material 110. For example, the support 102 may be constructed from a metal material, and the items 105 may then have magnets disposed thereon to facilitate coupling the items 105 to the support 102 (or vice versa). With that said, it can be seen that the coupling material 110 allows the items 105 to be removably coupled to the support 102 (e.g., to the lower portion 106 of the support 102 as illustrated in FIGS. 1 and 2, etc.) in any desired arrangement. As such, a user can hold/store the items 105 in the storage system 100 simply by coupling them to the support 102. The items 105 remain secured to the support 102, but in view, to allow a user to later access the items 105 (e.g., with the imaging unit 104, etc.) and/or select an item 105 for use by grabbing it and uncoupling it from the support 102. Then, when the user is finished with the item 105, the user can easily recouple it back to the support 102.

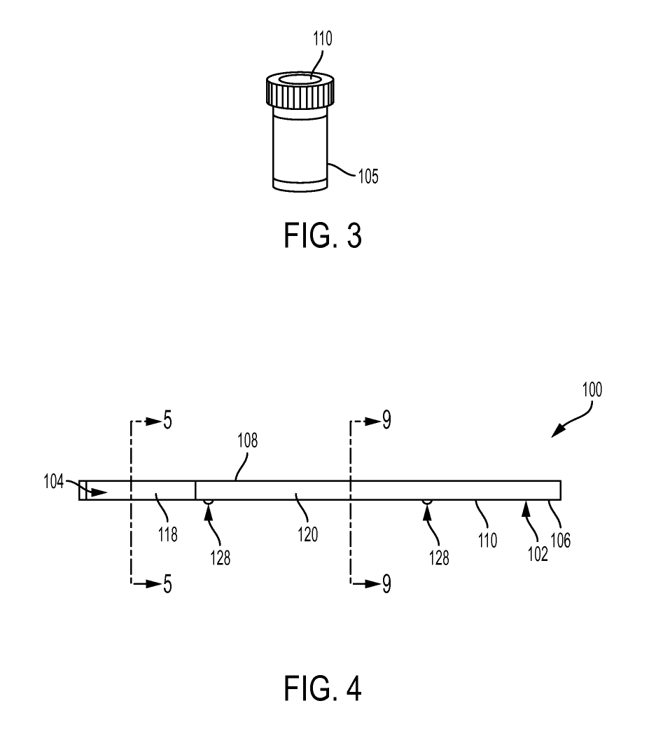

In the illustrated embodiment, the coupling material 110 includes hook and loop material applied to the support 102 and to the items 105. In particular, hook and loop material is provided (e.g., using an adhesive, etc.) along the lower portion 106 (e.g., the lower surface, etc.) of the support 102. And, corresponding (e.g., mating, etc.) patches of hook and loop material are provided (e.g., using an adhesive, etc.) on upper portions (e.g., lids, caps, etc.) of the items 105 (FIG. 3). As such, the items 105 can be releasably coupled, via the hook and loop material, to the lower portion 106 of the support 102 (FIGS. 1 and 2). This allows the items 105 to hang from the support 102 until a user wishes to remove them for use, as previously described. With that said, it should be appreciated that the hook and loop material (or any other potential coupling material) may be applied to other portions of the support 102 (e.g., along one or more side portions of the support 102, along the upper portion 108 of the support 102, etc.) and/or to other portions of the items 105 (e.g., along one or more side portions of the items 105, along upper portions of the items 105, etc.) to help facilitate coupling the items 105 to the support 102.

As also shown in FIG. 2, the imaging unit 104 of the storage system 100 generally includes a mount 112 and a magnifying lens 114 coupled to the mount 112. The mount 112 is configured to couple the imaging unit 104 to the support 102, and facilitate sliding movement of the imaging unit 104 relative to the support 102 to allow for locating the imaging unit 104 in desired locations along the support 102 (e.g., adjacent one or more of the items 105 coupled to the support 102 to help in viewing the items 105, etc.). And, when the imaging unit 104 is positioned adjacent the items 105, the magnifying lens 114 operates to magnify text, print, images, etc. on the items 105 to assist the user in viewing the items 105 and, in some aspects, determining the item type and/or contents. The magnifying lens 114 can include any suitable magnifying lens 114 within the scope of the present disclosure, and may also provide any desired magnification (e.g., 2× magnification, 4× magnification, 5× magnification, 8× magnification, etc.). Alternatively, in other exemplary embodiments, the imaging unit 104 may include a camera or other imaging device for use in viewing the items 105 in the storage system 100. In addition, it should be appreciated that while the illustrated imaging unit 104 is generally rectangular in shape, imaging units having other shapes (e.g., square shapes, circular shapes, etc.) may be used within the scope of the present disclosure.

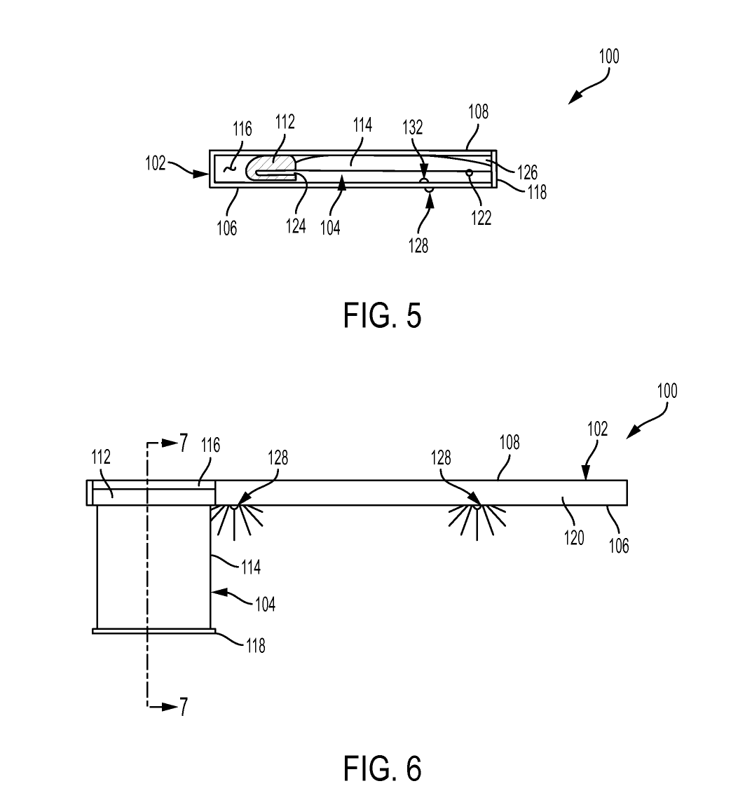

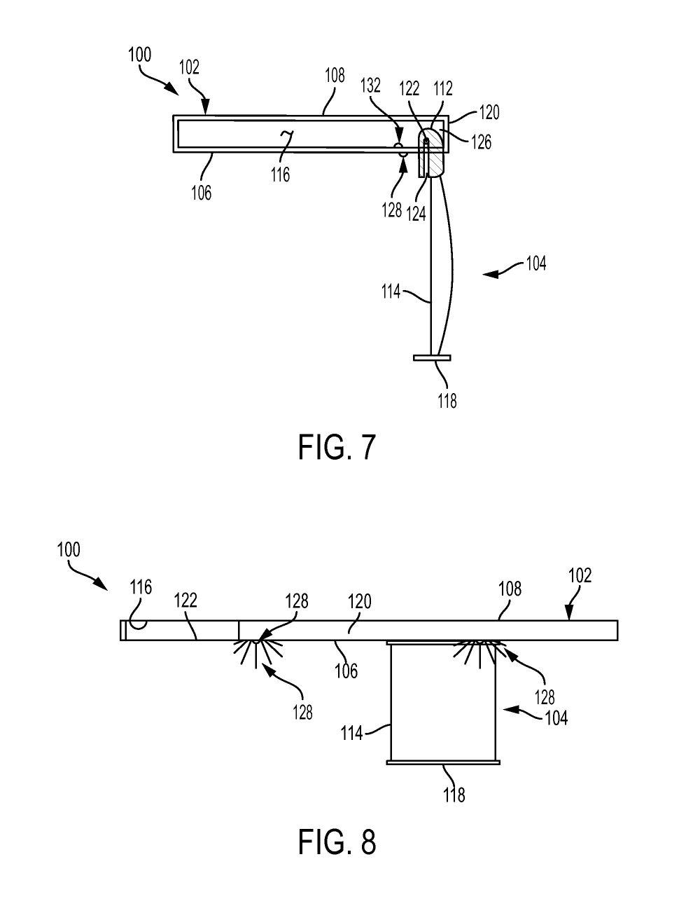

With additional reference now to FIGS. 4-9, the imaging unit 104 is moveable relative to the support 102 between multiple different positions. For example, as shown in FIGS. 4-7, the imaging unit 104 is moveable between a stored position (e.g., a first position, etc.) (FIGS. 4 and 5) and an extended position (e.g., a second position, etc.) (FIGS. 6 and 7). In the stored position, the imaging unit 104 is disposed within an opening 116 defined by the support 102, with a footing 118 of the imaging unit 104 (coupled to the magnifying lens 114) generally aligned with (e.g., substantially flush with, etc.) a forward lip 120 of the support 102. And, in the extended position, the imaging unit 104 is removed from the opening 116, and positioned generally vertically relative to the support 102, and available for use in viewing items 105 coupled to the support 102. In addition, when in the extended position, the imaging unit 104 is also moveable (e.g., slidable, etc.) along the support 102 between multiple further positions (e.g., a third position as shown in FIG. 8, etc.) for use in viewing select items 105 on the support 102 (see, FIG. 2).

In the illustrated embodiment, the opening 116 for receiving the imaging unit 104, in the stored position, is disposed generally between the upper portion 108 of the support 102 and the lower portion 106 of the support 102 (FIG. 5). And, access to the opening 116, by the imaging unit 104, is then provided through the forward lip 120 of the support 102. In other exemplary embodiments, the opening 116 of the support 102 may have other configurations capable of receiving the imaging unit 104. For example, the opening 116 may include a hollow portion of the support 102, a slot of the support 102, etc., or may be defined by a separate structure coupled to (or formed as part of) the support 102. In addition, the opening 116 may be approximately the same size as the imaging unit 104 or, alternatively, the opening 116 may be larger than the imaging unit 104. Further, the opening 116 may partially or completely enclose the imaging unit 104 when the imaging unit 104 is stored in the opening 116. For example, in some embodiments (and without limitation), the opening may have a width dimension of about 2.5 inches and a height dimension of about 0.875 inches, and may be located about 0.25 inches from a lateral edge portion of the support 102.

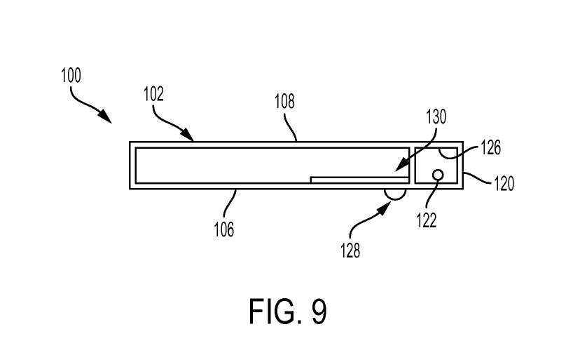

In moving the imaging unit 104 from the stored position to the extended position, the mount 112 of the imaging unit 104 moves into engagement with a rod 122 (broadly, a guide) of the storage system 100 extending generally along a forward portion (e.g., the forward lip 120, etc.) of the support 102 (see, FIGS. 5, 7, and 8). A slot 124 defined by the mount 112 moves generally over the rod 122, and the rod 122 moves into a generally upper portion of the slot 124 (FIG. 7). In this position, the imaging unit 104 (via the mount 112) is able to slide along the rod 122 substantially the entire length of the support 102 (thereby allowing the imaging unit 104 to be positioned in one of multiple different desired positions along the length of the support 102). In the illustrated embodiment, the rod 122 is disposed within a channel 126 of the support 102 located generally behind the forward lip 120 of the support 102 (FIG. 9). As such, the imaging unit 104 generally hangs from the rod 122, when in the extended position, and is able to slide along the rod 122 generally behind the forward lip 120 of the support 102. However, it should be appreciated that the rod 122 could be positioned differently within the scope of the present disclosure, for example, generally forward of the forward lip 120, generally below the forward lip 120, etc. In addition, while the rod 122 is illustrated in the storage system 100 for allowing relative movement of the imaging unit 104 along the support 102, other structures may be used within the scope of the present disclosure (e.g., magnets, wires, rollers, automated structures, slots, grooves, other guides, etc.). Further, although the imaging unit 104 is illustrated in the drawings as sliding along the forward lip 120 of the support 102, it is understood that in other embodiments the imaging unit 104 may be configured to move relative to the support 102 in other suitable manners to assist in viewing items 105 coupled to the support 102.

With reference again to FIGS. 1 and 2, the storage system 100 also includes lights 128 disposed on the support 102. A circuit 130 is provided (e.g., via a printed wire board (PWB), via a printed circuit board (PCB), etc.) to power and/or control the lights 128 (FIG. 9). The lights 128 are configured to illuminate the items 105 coupled to the support 102 to help a user view the items 105, particularly when using the imaging unit 104. And, the lights 128 can be selectively activated to provide such illumination, when needed.

In the illustrated embodiment, the lights 128 are configured to turn on automatically when the imaging unit 104 is removed from the opening 116 of the support 102, and to turn off automatically when the imaging unit 104 is returned to the opening 116. In particular, a switch 132 (e.g., a mechanical switch, an optical sensor, a motion detector, etc.) is positioned adjacent to the opening 116 of the support 102 (FIG. 5) (and in communication with the circuit 130, etc.), and the imaging unit 104 is configured to actuate the switch 132 when moving out of the opening 116 and when moving into the opening 116. As such, the lights 128 can be made available (e.g., activated, etc.) when the imaging unit 104 is removed from the opening 116 of the support 102 for illuminating the items 105 coupled to the support 102 while the user views the items 105 with the imaging unit 104. Then, once the user is finished and returns the imaging unit 104 to the stored position in the opening 116, the lights 128 turn off (e.g., to save energy, to reduce energy costs, to avoid undesired brightness in the storage system 100, etc.).

With that said, it should be appreciated that the lights 128 of the storage system 100 can be used to illuminate the items 105 in the storage system 100, or even other areas adjacent the storage system 100, independent of use of the imaging unit 104 within the scope of the present disclosure. In addition, it should also be appreciated that any suitable lights may be used in the storage system 100 within the scope of the present disclosure, including, for example, light emitting diode (LED) lights, filament bulbs, etc. And, while the lights 128 are shown generally under the support 102 in the illustrated embodiment, it should be appreciated that lights may be positioned differently within the scope of the present disclosure, for example, generally over (e.g., on the upper portion 108 of, etc.) the support 102, on the imaging unit 104, on the support 102 and on the imaging unit 104, etc. Further, the lights 128 may be activated in any suitable manner and/or at any desired time. For example, the lights 128 may be coupled to motion sensitive switches (e.g., disposed on the support 102, disposed on the imaging unit 104, combinations thereof, etc.), so that the lights 128 may automatically turn on when the imaging unit 104 moves (regardless of position), and then stay on for a predetermined time period, after which the lights 128 then turn off. In addition, the lights 128 may be coupled to a simple switch adjacent the opening 116, to thereby manually control turning the lights 128 on and/or off (independent of moving the imaging unit 104 and/or a position of the imaging unit 104). Or, the lights 128 may be coupled to a switch adjacent the opening 116 for detecting if the imaging unit 104 is in the stored position, to thereby automatically control turning the lights 128 on and/or off. Still further, the lights 128 may be coupled to sensors (e.g., disposed on the support 102, disposed on the imaging unit 104, combinations thereof, etc.) configured to activate and/or deactivate the lights 128 depending on particular positioning of the imaging unit 104 in the storage system 100.

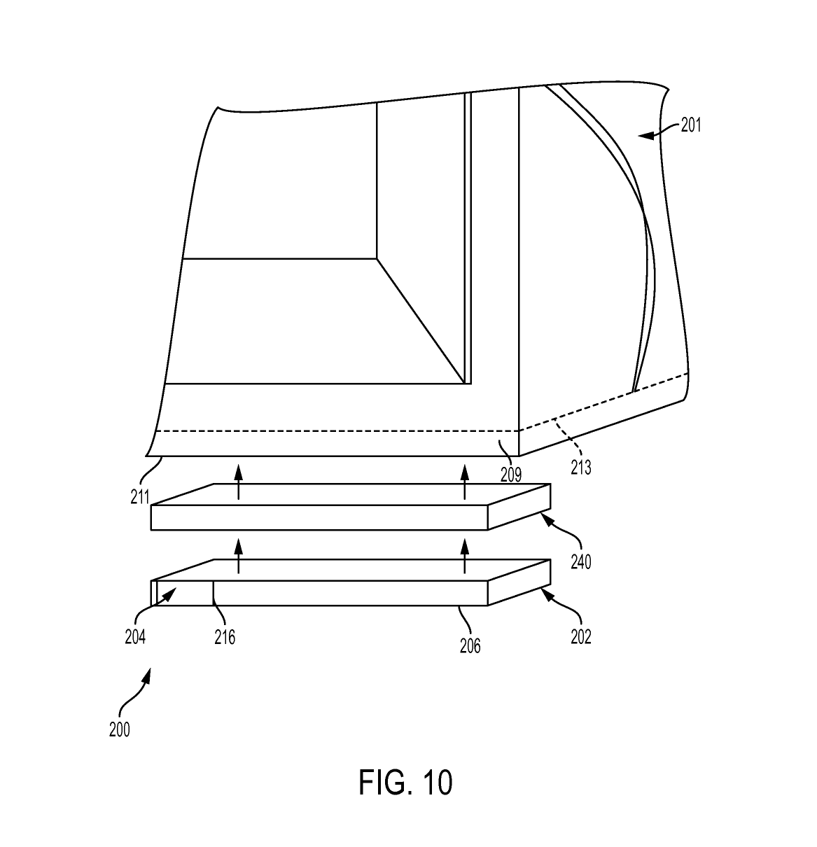

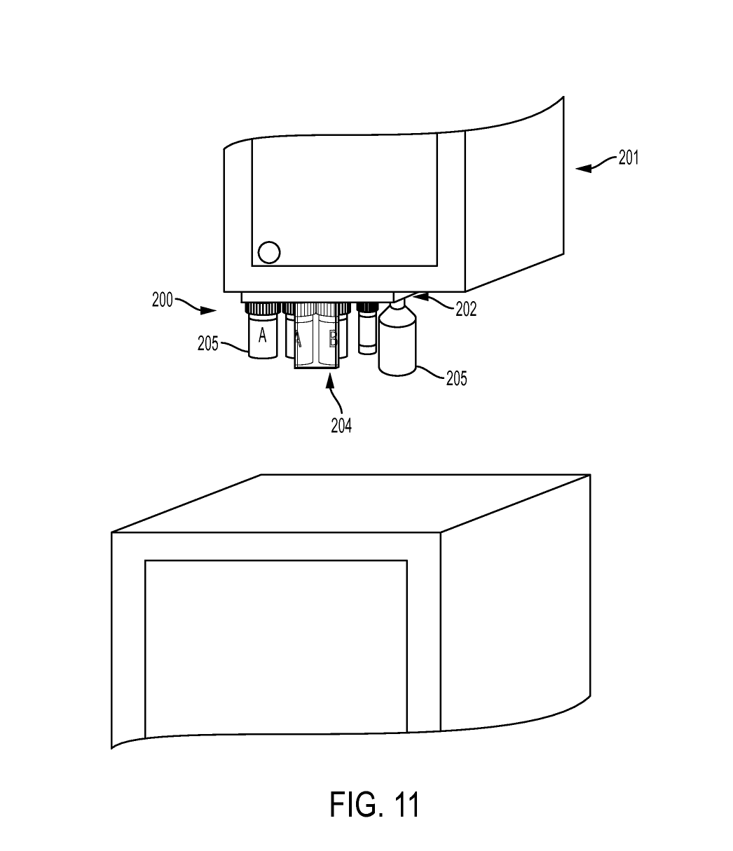

FIGS. 10 and 11 illustrate another exemplary embodiment of a storage system 200 including one or more aspects of the present disclosure. The storage system 200 is substantially similar to the storage system 100 previously described and illustrated in FIGS. 1-9. For example, the storage system 200 generally includes a support 202 and an imaging unit 204. The support 202 is substantially the same as the support 102 of the previous storage system 100, and the imaging unit 204 is substantially the same as the imaging unit 104 of the previous storage system 100. As such, the entire description of the previous storage system 100 generally applies to the storage system 200 of this embodiment.

In this embodiment, the storage system 200 is configured for installation to an underside of a cabinet 201. As shown in FIG. 10, the cabinet 201 includes a forward panel 209 that extends beyond, or overhangs at 211, an underside 213 of the cabinet 201. To accommodate the overhang 211, the illustrated storage system 200 further includes a spacer 240 configured to couple to the underside 213 of the cabinet 201, generally within the overhang 211 of the cabinet 201. And, the support 202 then couples to a lower portion of the spacer 240. The spacer 240 has a height such that, once coupled to the underside 213 of the cabinet 201, the support 202 coupled thereto is at least level with or below the overhang 211. This allows the imaging unit 204 to move relative to the support 202 (e.g., into and out of an opening 216 defined by the support 202, etc.), between a stored position (FIG. 10) and an extended position (FIG. 11) (as described for the previous storage system 100), without interference from the overhang 211. This also allows items 205 to be coupled to a lower portion 206 of the support 202 (as described for the previous storage system 100) without interference from the overhang 211 (FIG. 11) (e.g., instead of resting on a kitchen counter, etc. which may provide increased space savings by freeing up additional kitchen counter space for other uses).

It should be appreciated that the spacer 240 can be coupled to the underside 213 of the cabinet 201 using any suitable means (e.g., adhesives, mechanical fasteners, hook and loop materials, etc.). Similarly, the support 202 can be coupled to the lower portion of the spacer 240 by any suitable means (e.g., adhesives, mechanical fasteners, hook and loop materials, etc.). Further, in other exemplary embodiments, storage systems may include supports specifically sized to be installed to undersides of cabinets, generally behind overhangs of the cabinets, without requiring additional spacers.

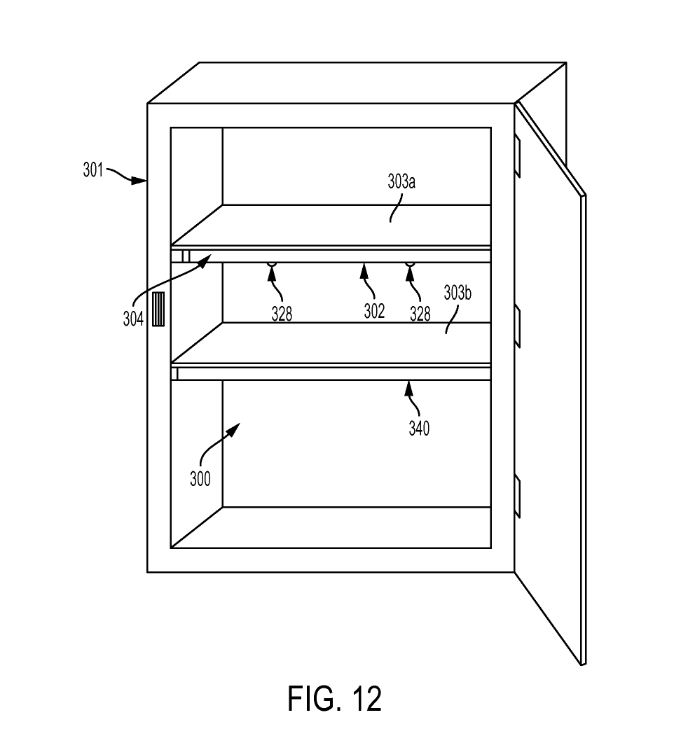

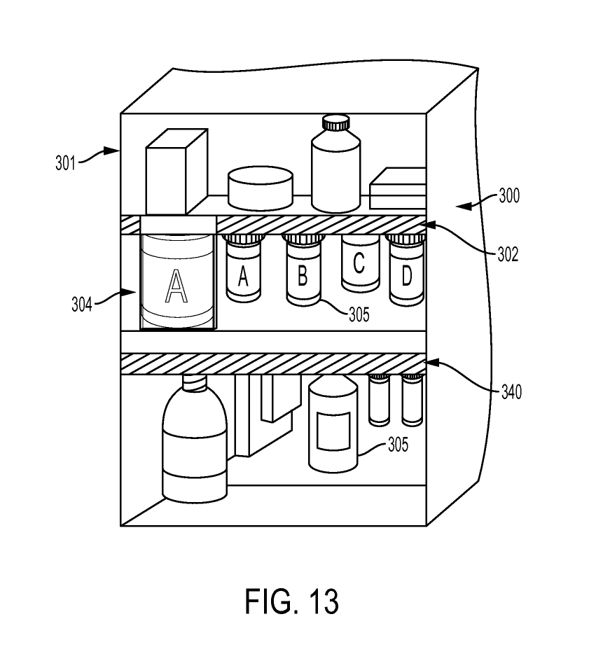

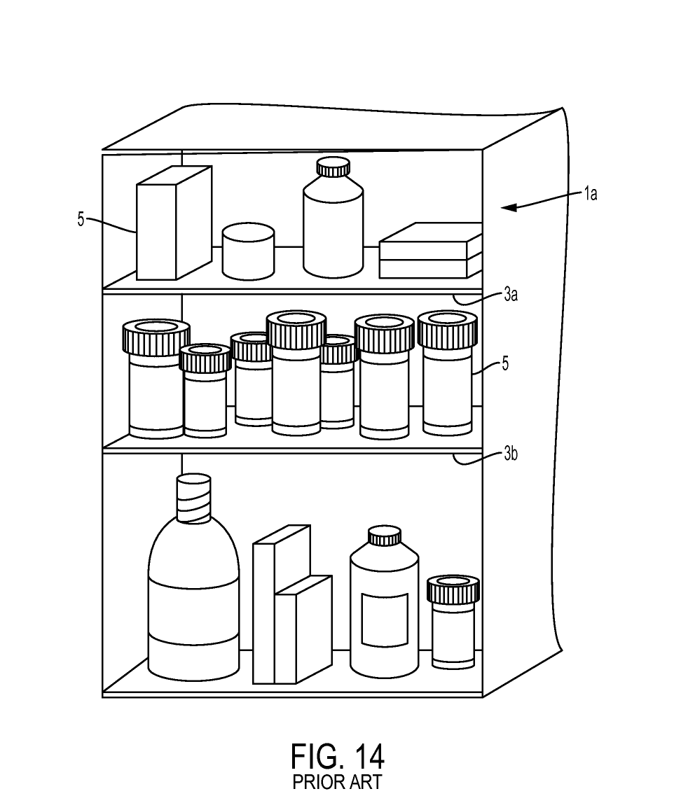

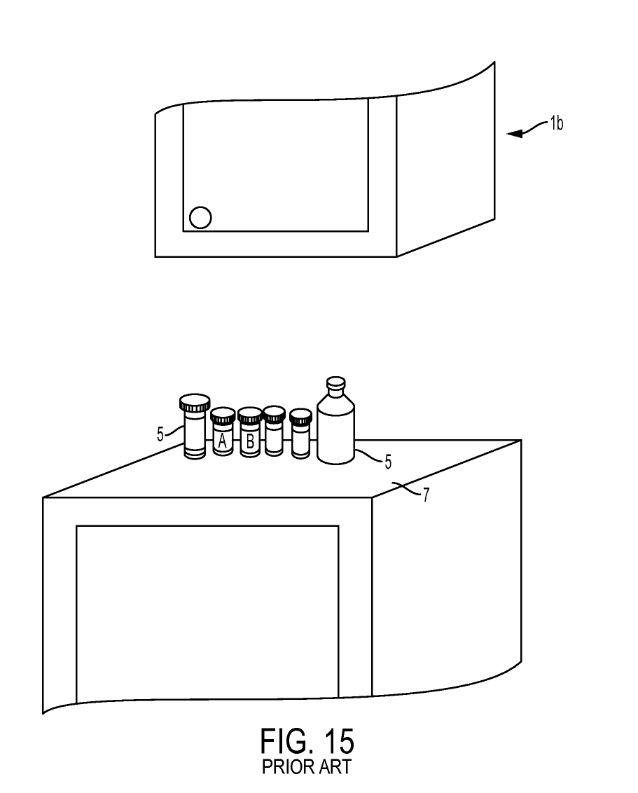

FIGS. 12 and 13 illustrate another exemplary embodiment of a storage system 300 including one or more aspects of the present disclosure. The storage system 300 is again substantially similar to the storage system 100 previously described and illustrated in FIGS. 1-9. For example, the storage system 300 generally includes a support 302, an imaging unit 304, and lights 328. And, the support 302 is substantially the same as the support 102 of the previous storage system 100; the imaging unit 304 is substantially the same as the imaging unit 104 of the previous storage system 100; and the lights 328 are substantially the same as the lights 128 of the previous storage system 100. As such, the entire description of the previous storage system 100 generally applies to the storage system 300 of this embodiment.

In this embodiment, the storage system 300 is configured for installation to a medicine cabinet 301. In particular, the support 302 of the storage system 300 is configured to be coupled to an underside of a first shelf 303a of the medicine cabinet 301, and a spacer 340 of the storage system 300 is configured to be coupled to an underside of a second shelf 303b of the medicine cabinet 301. The imaging unit 304 can then be used, as desired, in connection with the support 302, for viewing, etc. items 305 coupled thereto (as described for the previous storage system 100). In addition, the spacer 340 can include suitable coupling material, to allow for releasably coupling additional items 305 thereto (e.g., to an underside of the spacer 340, etc.) (as described for the previous storage system 100). In some aspects, the spacer 340 may be used for holding/storing larger and/or heavier items in a lower shelf location of the medicine cabinet 301.

It should be appreciated that the support 302 and/or the spacer 340 can be coupled to the underside of the shelves 303a, 303b using any suitable means (e.g., adhesives, mechanical fasteners, hook and loop materials, etc.). In addition, the support 302 and the spacer 340 may be coupled to shelves in medicine cabinets, in other embodiments, in different arrangements than illustrated in FIGS. 12 and 13. For example, the support 302 may be coupled to a lower shelf in a medicine cabinet, and the spacer 340 may be coupled to an upper shelf. Further, it should be appreciated that the support 302 and/or the spacer 340 may be positioned within the medicine cabinet 301 (or any other cabinet) and used directly as shelves in the medicine cabinet 301, without necessarily being coupled to existing shelves 303a, 303b in the medicine cabinet 301. Although this embodiment illustrates one support 302 and one spacer 340 in the medicine cabinet 301, it should be appreciated that additional (or fewer) supports and/or spacers may be used.

It should also be appreciated that, in some embodiments, the spacer 340 may also include lights configured to illuminate the items 305 coupled to the spacer 340 to help a user view the items 305. For example, the lights may be disposed on the spacer 340 at desired locations (e.g., similar to the lights 328 of the support 302, etc.), and a circuit may be provided (e.g., via a printed wire board (PWB), via a printed circuit board (PCB), etc.) to power and/or control the lights. And, the lights may be selectively activated to provide such illumination when needed (e.g., manually, automatically, etc.). In addition, any suitable lights may be used including, for example, light emitting diode (LED) lights, filament bulbs, etc. Further, the lights may be activated in any suitable manner and/or at any desired time (e.g., the lights may be coupled to a motion sensitive switch, the lights may be coupled to a simple switch to thereby manually control turning the lights on and/or off, combinations thereof, etc.).

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that exemplary embodiments may be embodied in many different forms, and that neither should be construed to limit the scope of the disclosure. In some exemplary embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Or for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A storage system for items, the system comprising:
a support for holding items, at least a portion of the support defining an opening; and
an imaging unit coupled to the support, the imaging unit moveable between a first position in which the imaging unit is disposed generally within the opening of the support and a second position in which the imaging unit is disposed generally outside of the opening, for use in viewing the items when held by the support.

2. The system of claim 1, wherein the support includes a coupling material for use in releasably coupling the items to the support.

3. The system of claim 2, wherein the coupling material is at least partially disposed on a lower portion of the support.

4. The system of claim 2, wherein the coupling material includes hook and loop material.

5. The system of claim 2, wherein the coupling material is a first coupling material, and wherein the items each including a second coupling material configured to mate with the first coupling material for use in removably coupling the items to the support.

6. The system of claim 1, wherein the imaging unit includes a magnifying lens configured to magnify text and/or images on the items held by the support.

7. The system of claim 1, further comprising one or more lights, the one or more lights configured to provide light to at least a portion of at least one of the items when held by the support to thereby assist a user in viewing the at least one of the items.

8. The system of claim 7, wherein the one or more lights are disposed on the support.

9. The system of claim 7, wherein the one or more lights are disposed on the imaging unit.

10. The system of claim 7, wherein the one or more lights are configured to turn on automatically when the imaging unit moves from the first position to the second position.

11. The system of claim 7, wherein the one or more lights are configured to turn off automatically when the imaging unit moves from the second position to the first position.

12. The system of claim 7, wherein the one or more lights are activated by movement of the imaging unit.

13. The system of claim 7, wherein the one or more lights include at least one light emitting diode.

14. The system of claim 1, wherein support includes a guide configured to support the imaging unit when in the second position and allow movement of the imaging unit relative to the support, for use in viewing the items when held by the support.

15. The system of claim 1, wherein the support is configured for installation to a medicine cabinet.

16. The system of claim 1, wherein the support is configured for installation to an underside of a cabinet.

17. A storage system for items, the system comprising:
a housing, the housing including coupling material for releasably coupling one or more items to the housing;
a magnifying lens coupled to the housing, the magnifying lens moveable between a plurality of positions relative to the housing to allow a user to selectively magnify at least a portion of one or more items coupled to the housing; and
one or more lights configured to automatically turn on when the magnifying lens is moved relative to the housing, to provide light to at least a portion of the one or more items coupled to the housing to assist the user in viewing text and/or images on the one or more items.

18. The system of claim 17, wherein the housing defines an opening, and wherein the magnifying lens is moveable between a stored position in which the magnifying lens is at least partially positioned within the opening and a second position in which the magnifying lens is positioned out of the opening for use in magnifying the at least a portion of the one or more items coupled to the housing; the one or more lights configured to turn off automatically when the magnifying lens is at least partially positioned within the opening.

19. The system of claim 17, wherein the one or more lights includes at least one light emitting diode.
